(19) United States
(12) Patent Application Publication
(10) Pub. No.: US 2008/0301381 A1
(43) Pub. Date: Dec. 4, 2008

(54) DEVICE AND METHOD FOR CONTROLLING COMMANDS USED FOR FLASH MEMORY

(75) Inventors: Dong-woo LEE, Suwon-si (KR); Houng-sog Min, Ansan-si (KR); Shin-wook Kang, Hwaseong-si (KR); Hyang-suk Park, Suwon-si (KR); Seong-hun Jeong, Suwon-si (KR); Sang-seob Shin, Suwon-si (KR); Hye-lime Jeong, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/099,287

(22) Filed: Apr. 8, 2008

(30) Foreign Application Priority Data
May 30, 2007 (KR) 10-2007-0052920

(51) Int. Cl. G06F 12/00

(52) U.S. Cl. 711/154; 711/E12.001

(57) ABSTRACT

A method and device for controlling commands used for a flash memory are provided. The method includes, substantially reducing usage of a central processing unit (CPU) and a bus, when controlling the flash memory, by receiving information on at least one command currently stored in a system memory, receiving a command represented by the received information from the system memory, and generating an interrupt representing that all the commands are received, when receiving of substantially all the commands represented by the received information is completed.

### CROSS-REFERENCE TO RELATED PATENT APPLICATION

This application claims the benefit of Korean Patent Application No. 10-2007-0052920, filed on May 30, 2007 in the Korean Intellectual Property Office, the disclosure of which is incorporated herein in its entirety by reference.

### BACKGROUND OF THE INVENTION

1. Field of the Invention

Apparatuses and methods consistent with the present invention relate to controlling commands used for a flash memory, and more particularly, to controlling commands by using a direct memory access (DMA) controller that serves to write commands onto a system memory or read commands from the system memory independently of a central processing unit (CPU).

2. Description of the Related Art

As related art multimedia techniques have developed, various multimedia files are being increasingly used, such as multimedia files for a mobile device. Since related art high definition multimedia services have started to be provided, the sizes of the multimedia files have increased. Accordingly, there is a related art need for the reading and writing speeds of portable storage devices to increase more than related art speeds.

FIG. 1 is a block diagram illustrating a related art NAND flash memory control device 160 for controlling commands, including a host interface 110, a bus interface 120, a control unit 130, a register unit 140, and a NAND flash memory interface 150. The register unit 140 includes a command register 142, a command register status register 144, and a ready/busy (R/B) status register 146.

The host interface 110 controls an input and an output of data or commands between the related art NAND flash memory control device 160 and an external host (not shown).

The bus interface 120 controls communication of data or commands between the related art NAND flash memory control device 160 and a central processing unit (CPU) (not shown) or a flash translation layer (FTL) (not shown) through a system bus. The FTL serves to transform a logical address in a file system into a physical address in a flash memory. If a file system, such as a file allocation table (FAT), for a general magnetic disk is used, it is possible to control the flash memory by using the FTL.

The control unit 130 controls the operations of components included in the related art NAND flash memory control device 160.

The register unit 140 stores commands for controlling a NAND flash memory 170, and a status (Full or Not full) representing whether there is a space for storing the commands for controlling the NAND flash memory 170. A full status represents that there is no space in the register unit 140 for storing the commands. A not full status represents that there is a space in the register unit 140 for storing the commands.

The command register 142 serves to store commands for requesting data to be recorded onto the NAND flash memory 170 or to be read from the NAND flash memory 170, and the stored commands may be stored in the command register 142 in a queue such as a first-in-first-out queue. Also, the command register 142 may be constructed with a plurality of registers.

The command register status register 144 represents a status indicating whether there is a space for storing the commands in the command register 142. When the command register 142 includes the plurality of registers, the command register status register 144 may indicate whether there is a space for storing the commands in each of the registers of the command register 142 corresponding to a channel or NAND flash memory device. Accordingly, the number of registers of the command register status register 144 may be the same as the number of NAND flash memory devices 0 to N of the NAND flash memory 170 or the number of channels of the NAND flash memory 170. The NAND flash memory devices 0 to N indicate flash memory chips that form the NAND flash memory 170. A channel indicates a group constructed with a number of NAND flash memory devices from among the NAND flash memory devices 0 to N. For example, when there are sixteen NAND flash memory devices, four NAND flash memory devices are grouped into one channel so that there are a total of four channels.

There are (N+1) R/B status registers in the R/B status register 146 in correspondence with the NAND flash memory devices 0 to N in the NAND flash memory 170, and the R/B status registers indicate a ready/busy status of the NAND flash memory devices 0 to N. When a status of one of the NAND flash memory devices 0 to N is busy, the NAND flash memory device that is busy is read or written by the related art NAND flash memory control device 160. When a status of one of the NAND flash memory devices 0 to N is ready, the NAND flash memory device that is ready is not read and not written by the related art NAND flash memory control device 160.

The NAND flash memory interface 150 controls an input and an output of data of the NAND flash memory 170.

FIG. 2 is a flowchart of a method of controlling commands used for a related art NAND flash memory control device 160.

When an external host or internal FTL requests data to be read from or written onto the channel or NAND flash memory device of the NAND flash memory 170, the related art NAND flash memory control device 160 receives a command corresponding to the request from the CPU or FTL and records the received command into the command register 142 such that the recorded command is stored in the command register 142 in the queue manner, in operation 210.

In operation 220, the related art NAND flash memory control device 160 determines the R/B status of the NAND flash memory device, in which the command is to be executed, through the R/B status register 146. When it is determined that the status of the NAND flash memory device is ready, the next command is received. When it is determined that the status of the NAND flash memory device is busy, the current operation proceeds to operation 230.

In operation 230, the related art NAND flash memory control device 160 determines if a space exists for storing commands in the command register 142 based on information stored in the command register status register 144. When there is no space for storing the commands in the command register 142, a full flag is stored in the command register status register 144. When there is a space for storing the commands in the command register 142, a not full flag is stored in the command register status register 144. In case of the not full flag, the next command is received. When it is determined that the full flag is there, the current operation proceeds to operation 240.

In operation 240, it is determined whether the related art NAND flash memory control device 160 is in an interrupt mode or polling mode. In the interrupt mode, when an event in which there is no space for storing the commands in a register of the related art NAND flash memory control device 160 occurs, an interrupt is generated and reported to the CPU. In a polling mode, when there is no space for storing commands in a register of the related art NAND memory control device 160, software directly reads the command register status register 144 and controls the related art NAND flash memory control device 160. When it is determined that the related art NAND flash memory control device 160 is not in the interrupt mode, that is, when the related art NAND flash memory control device 160 is in the polling mode, the current operation proceeds to operation 260. When the related art NAND flash memory control device 160 is in the interrupt mode, the current operation proceeds to operation 250.

In operation 250, the related art NAND flash memory control device 160 generates an interrupt CMD REG FULL so as to report to the CPU that there is no space for storing commands in the command register 142, when it is determined that the related art NAND flash memory control device 160 is in the interrupt mode in operation 240. When the interrupt CMD REG FULL occurs, the CPU processes a predetermined interrupt routine. When it is determined that the related art NAND flash memory control device 160 is in the polling mode in operation 240, since the current operation proceeds to operation 260 by skipping operation 250, it is unnecessary to generate an interrupt.

In operation 260, when it is determined that the NAND flash memory control device 160 is in the polling mode in operation 240 or when the interrupt CMD REG FULL is generated in operation 250, the R/B status of the NAND flash memory device in which the command received in operation 210 is to be executed is determined based on the information from the R/B status register 146. When it is determined that the R/B status is ready, the current operation proceeds to operation 270. When it is determined that the R/B status is busy, the current operation is put on standby until the R/B status is ready.

In operation 270, when it is determined that the R/B status of the related art NAND flash memory control device 160 is ready in operation 260, it is determined whether the related art NAND flash memory control device 160 is in the interrupt mode. When it is determined that the related art NAND flash memory control device 160 is not in the interrupt mode, that is, when the related art NAND flash memory control device 160 is in the polling mode, software directly reads the R/B status of the NAND flash memory device from the R/B status register 146. When it is determined that the related art NAND flash memory control device 160 is in the interrupt mode, the current operation proceeds to operation 280.

In operation 280, the related art NAND flash memory control device 160 generates an interrupt CMD REG NOT FULL to report the CPU that there is a space for storing commands in the command register 142. Thus, the CPU skips the predetermined interrupt routine performed in operation 250 due to the interrupt CMD REG NOT FULL.

FIG. 3 is a schematic diagram illustrating a related art four channel-four way architecture of the NAND flash memory 170.

Referring to FIGS. 2 and 3, the related art NAND flash memory control device 160 controls sixteen NAND flash memory devices included in the NAND flash memory 170 by using four channels, that is, channel 0, channel 1, channel 2, and channel 3. Channel 0 includes a NAND flash memory device 0-0, a NAND flash memory device 0-1, a NAND flash memory device 0-2, and a NAND flash memory device 0-3. Channel 1 includes a NAND flash memory device 1-0, a NAND flash memory device 1-1, a NAND flash memory device 1-2, and a NAND flash memory device 1-3. Channel 2 includes a NAND flash memory device 2-0, a NAND flash memory device 2-1, a NAND flash memory device 2-2, and a NAND flash memory device 2-3. Channel 3 includes a NAND flash memory device 3-0, a NAND flash memory device 3-1, a NAND flash memory device 3-2, and a NAND flash memory device 3-3. When the related art NAND flash memory control device 160 controls the NAND flash memory 170 by using 32 bits, 8 bits are allocated to each of the four channels. There are four NAND flash memory devices in each of the four channels, and the four NAND flash memory devices share 8 bits such that the four NAND flash memory devices share the allocated 8 bits by using a chip enable signal for driving the four NAND flash memory devices. That is, a NAND flash memory device into which the chip enable signal is input can use the allocated 8 bits.

When the related art method of controlling the NAND flash memory 170 is defined as a task and when each received command is processed by using the method shown in FIG. 2, a starting time is not overlapped, and tasks are executed for each of the four channels or the sixteen NAND flash memory devices in parallel with one another due to a multi-channel structure and in an interleaving manner.

FIG. 4 is a timing diagram of the foregoing related art system, when data is recorded onto the NAND flash memory 170. The timing diagram illustrates tasks concurrently executed for each of the four channels, and it is assumed that the transmission speed of the data from the host to the NAND flash memory control device 160 is sufficiently high.

A program time indicates a time for which data is electrically charged from a data buffer (not shown) of the NAND flash memory 170 to a NAND flash memory device. The time denotes a time for which data is recorded on the NAND flash memory device. Referring to FIG. 4, when each of the four channels operates in a four way interleaving manner, the program time is reduced, and the four channels operate in a parallel manner. For example, in case of the channel 0, a page 0, which is a time allocated to the NAND flash memory device 0-0, is 51.44 μs. When each of the four channels does not operate in the four way interleaving manner, the program time is 200.27 μs (251.71-51.44) that is four times of the page 0. However, when the four channel-four way architecture of FIG. 3 is used, since the pages 0, 4, 8, and 12 may be respectively allocated to the NAND flash memory devices 0-0, 0-1, 0-2, and 0-3, as shown in FIG. 4, the program time of the channel 0 is reduced to 45.95 μs (251.71-51.44*4). Referring to FIG. 4, when each of the four channels operates in the four way interleaving manner and when the method shown in FIG. 2 starts after receiving a new command at an interval of about 15.7 μs (251.71/16), the four channel-four way architecture shown in FIG. 3 reaches the best performance. Also, from the calculation of (251.71/16), 251.71 μs indicates a time allocated to the channel 0, and 16 indicates the number of NAND flash memory devices included in the NAND flash memory 170.

However, when an interrupt occurs at an interval of about 15.7 μs an excessive load for processing the interrupt is generated in the entire system, and accordingly, the performance of the system is decreased. Specifically, according to the aforementioned related art technique, when processing massive data, the interrupt CMD REG FULL and the interrupt CMD REG NOT FULL are generated for each command after transmitting a predetermined amount of data. Even in the polling mode, since the CPU uses a bus through polling for the most time for which data is transmitted, deterioration in the performance of the system due to the usage of the bus and an unnecessary power loss may occur in the polling mode.

As the transmission speed of the data increases, more interrupts for communicating information on the command register 142 are generated between the CPU and the related art NAND flash memory control device 160, and accordingly, the performance of the system may further deteriorate. Although a queuing capacity of the command register 142 increases, there might be a related art problem in that costs are increased, in order to obtain a sufficient capacity for transmitting massive multimedia files and reduce occurrences of interrupts.

### SUMMARY OF THE INVENTION

The present invention provides a method and device for controlling commands used for a flash memory by using a direct memory access (DMA) controller to process commands for reading and writing data from and onto the flash memory. The present invention also provides a computer-readable recording medium having embodied thereon a computer program for executing the aforementioned method.

According to an aspect of the present invention, there is provided a method of controlling commands used for a flash memory, the method comprising: receiving information on at least one command currently stored in a system memory; receiving a command represented by the received information from the system memory; and generating an interrupt representing that all the commands are received, when receiving of all the commands represented by the received information is completed.

According to another aspect of the present invention, there is provided a computer-readable recording medium having embodied thereon a computer program for executing the aforementioned method of controlling the commands used for the flash memory.

According to another aspect of the present invention, there is provided a device for controlling commands for a flash memory, the device comprising: a first register storing information on at least one command currently stored in a system memory; and a DMA controller receiving commands represented by the information stored in the first register from the system memory and generating an interrupt representing that all the commands are received when all the commands represented by the stored information are received.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art NAND flash memory control device for controlling commands;

FIG. 2 is a flowchart of a method of controlling commands used for a related art NAND flash memory control device;

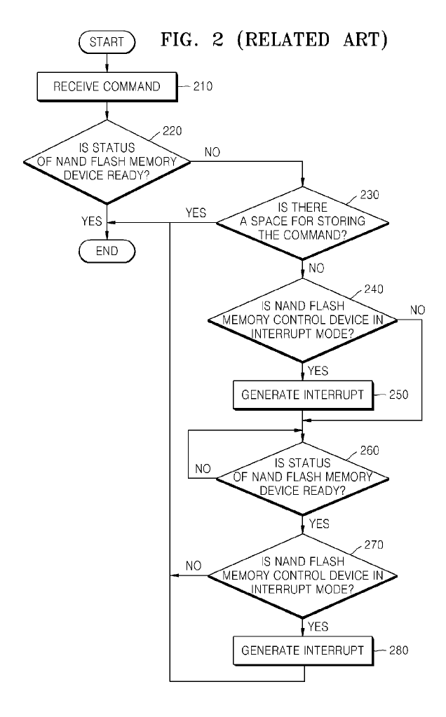

FIG. 3 is a schematic diagram illustrating a related art four channel-four way architecture of a NAND flash memory;

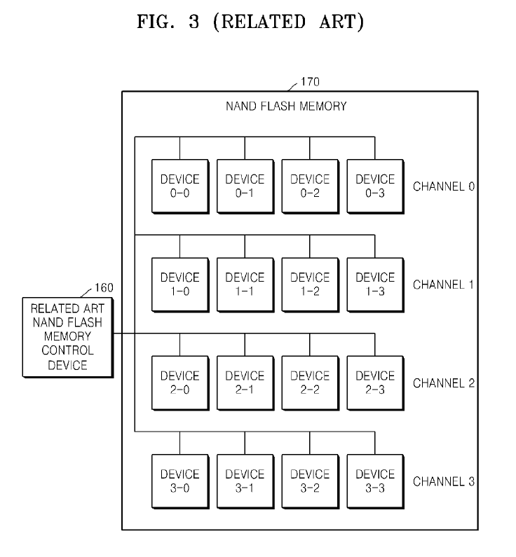

FIG. 4 is a related art timing diagram when data is recorded onto the NAND flash memory;

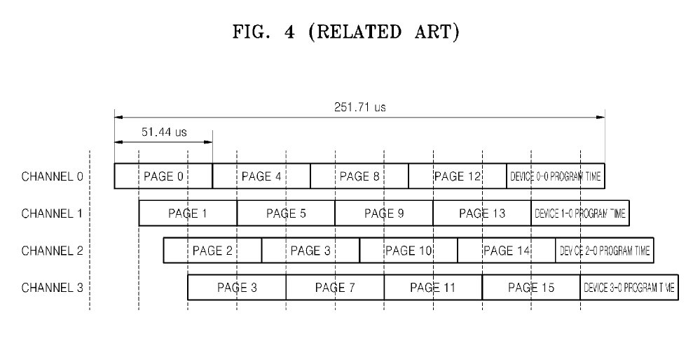

FIG. 5 is a block diagram illustrating a command control device for controlling commands used for a flash memory according to an exemplary embodiment of the present invention;

FIG. 6 is a flowchart of a method of controlling commands used for a flash memory according to an exemplary embodiment of the present invention;

FIG. 7 is a block diagram illustrating a flash memory control device including the command control device for controlling commands used for the flash memory shown in the exemplary embodiment of FIG. 5; and

FIG. 8 is a flowchart of an operation of a flash memory control device including the device for controlling commands used for the flash memory shown in the exemplary embodiment of FIG. 5.

### DETAILED DESCRIPTION OF EXEMPLARY EMBODIMENTS OF THE INVENTION

Hereinafter, exemplary embodiments will be described in detail with reference to the attached drawings.

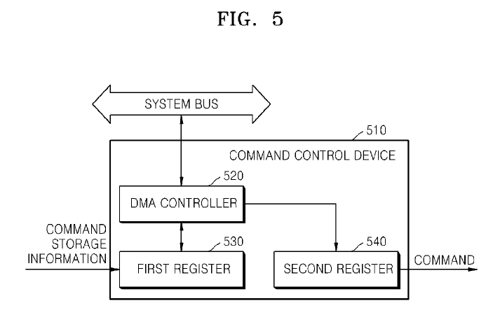

FIG. 5 is a block diagram illustrating a command control device 510 for controlling commands used for a flash memory according to an exemplary embodiment of the present invention.

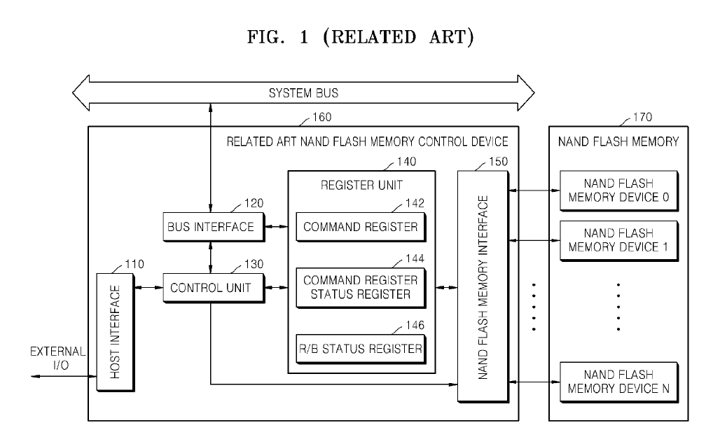

Hereinafter, a full description on the structure of the command control device 510 shown in FIG. 5 will be omitted for aspects of which the structure is substantially the same as the structure of the related art NAND flash memory control device shown in FIG. 1. However, the difference between the structures will be described. In addition, like reference numerals in the drawings denote like elements, and thus their description will be omitted.

Referring to FIG. 5, the command control device 510 is constructed with a DMA controller 520, a first register 530, and a second register 540.

The command control device 510 receives commands stored in a system memory (not shown) through a system bus without intervening of the CPU based on command storage information stored by the CPU and outputs the received commands to a device for executing the commands. The command storage information may be the number of commands stored in the system memory or an address in the system memory in which the commands are stored. The command control device 510 is included in a flash memory control device for controlling the flash memory.

The first register 530 is a register in which the command storage information for accessing the commands stored in the system memory is stored by the CPU.

The DMA controller 520 receives the commands stored in the system memory (not shown) through the system bus based on the command storage information stored in the first register 530 without intervening of the CPU, and the received commands are stored in the second register 540 in a queue manner. When all the commands that are stored in the system memory are received in the second register 540, the DMA controller 520 reports to the CPU that the receiving of the data of the DMA controller 520 is completed by generating an interrupt.

The second register 540 indicates a register in which the commands received from the DMA controller 520 are stored, and the received commands may be stored in the queue manner, and the received commands are output to a device in order to firstly execute the firstly stored command.

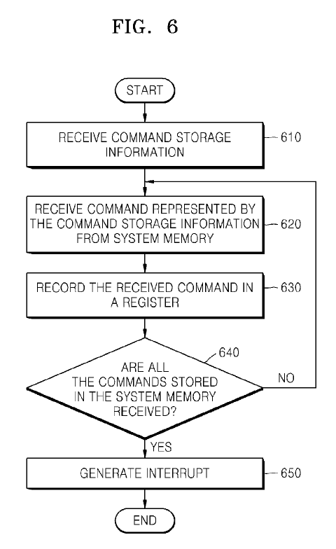

FIG. 6 is a flowchart of a method of controlling commands for a flash memory according to an exemplary embodiment of the present invention.

Referring to FIG. 6, the method of controlling commands according to this exemplary embodiment includes a sequence of operations processed by the command control device 510 shown in FIG. 5. Accordingly, although the full description on the structure of the command control device 510 is omitted as stated above, the description on the structure of the command control device 510 is also applied to the method of controlling commands according to the exemplary embodiment. The method of controlling the commands will be described with reference to FIGS. 5 and 6.

In operation 610, the command control device 510 receives the command storage information on the commands currently stored in the system memory from the CPU and stores the received command storage information in the first register 520.

In operation 620, the command control device 520 receives the commands represented by the command storage information stored in the first register 520 from the system memory.

In operation 630, the command control device 510 records the commands received in operation 620 in the second register 540.

In operation 640, the command control device 510 determines whether all the commands stored in the system memory are received. When it is determined that some commands remain in the system memory, the current operation proceeds to operation 620. When it is determined that there is not any commands that remain in the system memory, the current operation proceeds to operation 650.

In operation 650, the command control device 510 reports to the CPU that all the commands have been received by generating an interrupt. As described above, in the method of controlling commands used for the flash memory according to the present exemplary embodiment, since the interrupt is generated after all the commands stored in the system memory have been received, the interrupt occurs substantially less frequently as compared with the related art technique in which an interrupt occurs whenever a command is received, that is, when an overflow occurs.

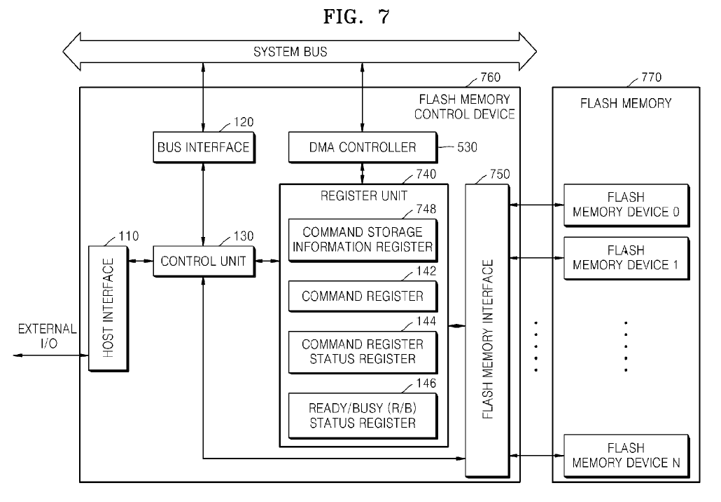

FIG. 7 is a block diagram illustrating a flash memory control device 760 according to an exemplary embodiment, including the command control device 510 for controlling commands for the flash memory shown in FIG. 5.

Referring to FIG. 7, the flash memory control device 760 is constructed with a host interface 110, a bus interface 120, a control unit 130, a register unit 740, a flash memory interface 750, and the DMA controller 530. The register unit 740 is constructed with a command register 142, a command register status register 144, a ready/busy (R/B) status register 146, and a command storage information register 748.

Hereinafter, a description on the structure of the flash memory control device 760 will be omitted since its structure is substantially the same as the structure of the devices shown in FIGS. 1 and 5. However, the difference between the structures will be described. In addition, like reference numerals in the drawings denote like elements, and thus their description will be omitted.

An embedded system or memory card may include the flash memory control device 760 and the flash memory 770.

The register unit 740 further includes the command storage information register 748 in addition to the structure of the register unit 140 shown in FIG. 1 including the command register 142 for storing commands for controlling the flash memory 770 and the command register status register 144 for storing a status representing whether there is a space for storing the commands in the register unit 140.

The command storage information register 748 indicates a register for storing the number of the commands to be read from the system memory and an address in the system memory in which the commands are stored, and the command storage information register 748 corresponds to the first register 520 of FIG. 5. The commands may be stored in the system memory by the CPU or FTL.

The DMA controller 530 serves to read a plurality of commands stored in the system memory based on the command storage information stored in the command storage information register 748 without intervening of the CPU and record the read commands in the command register 142 that corresponds to the second register 540 of FIG. 5.

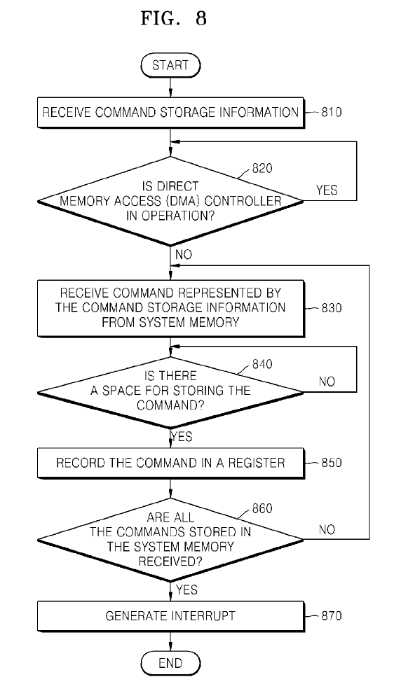

FIG. 8 is a flowchart of an operation of a flash memory control device including the command control device for controlling commands used for a flash memory, as shown in FIG. 5. The operation of the flash memory control device will be described with reference to FIGS. 7 and 8.

When an external host (not shown) or internal FTL requests data to be read from or written onto a channel or a flash memory device 0 to N of the flash memory 770, the host or FTL generates a command corresponding to the request and stores the generated command in the system memory. The stored commands may be stored in the system memory in a queue.

In operation 810, the flash memory control device 760 receives command storage information for reading the commands stored in the system memory from the CPU or FTL and stores the received command storage information in the command storage information register 748. The command storage information includes the number of the commands stored in the system memory and the address in the system memory in which the commands are stored.

In operation 820, the flash memory control device 760 determines whether the status of the DMA controller 530 is ready. A case where the status of the DMA controller 530 is ready indicates that the DMA controller 530 does not operate. A case where the status of the DMA controller 530 is busy indicates that the DMA controller 530 performs an operation such as reading of commands from the system memory. When it is determined that the status of the DMA controller 530 is ready, the current operation proceeds to operation 830. When it is determined that the status of the DMA controller 530 is busy, the current operation is on standby until the status of the DMA controller 530 is ready.

In operation 830, when it is determined that the DMA controller 530 is ready in operation 820, the DMA controller 530 reads the commands stored in the system memory based on the command storage information stored in operation 810.

In operation 840, the flash memory control device 760 determines whether there is a space for storing a command in the command register based on information stored in the command register status register 144. When it is determined that there is no space for storing a command (full flag), the current operation is on standby. When it is determined that there is a space for storing a command (not full flag), the current operation proceeds to operation 850.

In operation 850, the DMA controller 530 records the commands, which are read in operation 830, onto the command register 142 in a queue.

In operation 860, it is determined whether the flash memory control device 760 reads commands to the extent of the number of commands represented by the command storage information received in operation 810. When it is determined that the flash memory control device 760 does not read the commands to the extent of the number of commands represented by the command storage information received in operation 810, the current operation proceeds to operation 830, and the commands remaining in the system memory are read. When it is determined that the flash memory control device 760 reads the commands to the extent of the number of commands represented by the command storage information received in operation 810, the current operation proceeds to operation 870.

In operation 870, the flash memory control device 760 generates an interrupt representing that an operation of reading a command stored in the system memory is completed, and the interrupt is generated by the DMA controller 530. The CPU receives a report on the operation of the flash memory control device 760 by receiving the generated interrupt. As described above, it is possible for the flash memory control device 760 according to an embodiment of the present invention to receive a plurality of commands for writing or reading data onto or from the flash memory 770 from the system memory through only a single interrupt. In a case where the method shown in FIG. 8 is regarded as a single task, when the number of registers of the command storage information register 748 for providing the command storage information for accessing the commands stored in the system memory is equal to or greater than two, two or more tasks may occur in parallel with one another based on two or more command storage information. Thus, the starting times of the generated tasks are substantially different from one another.

According to an exemplary embodiment, it is possible to reduce the number of interrupts that occur whenever commands overflow in a register and to control the interrupt interval sufficiently wide even when transmitting massive data by storing commands in a partial area of the system memory and allowing a flash memory control device to include a DMA controller that accesses the stored commands. Accordingly, it is possible to substantially minimize operations except for the operation of inputting and outputting data into and from a flash memory. That is, it is possible to minimize operations, such as an operation of generating an interrupt for exchanging status information of a register for storing a command between a CPU and the flash memory control device. Accordingly, it is possible to embody a high speed input and output storage apparatus capable of reducing an amount of usage of the CPU and a bus as compared with the related art technique, and it is also possible to minimize an interaction with hardware when embodying an FTL and reduce complexity of the exemplary embodiment.

The exemplary embodiments of the present invention can be written as computer programs and can be implemented in general-use digital computers that execute the programs using a computer readable recording medium. In addition, data structures used for the embodiments of the present invention can be recorded in the computer readable recording medium through various means. Examples of the computer readable recording medium include magnetic storage media (e.g., ROM, floppy disks, hard disks, etc.), and optical recording media (e.g., CD-ROMs, or DVDs), other storage media. However, the present invention is not limited thereto.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling commands for a flash memory, the method comprising:
receiving information on at least one command currently stored in a system memory;
receiving a command represented by the received information from the system memory; and
generating an interrupt representing that all commands for the flash memory are received, if receiving of all the commands represented by the received information has been completed.

2. The method of claim 1, wherein information on the at least one command currently stored in the system memory comprises:
a number of commands stored in the system memory; and
an address in the system memory in which the commands are stored.

3. The method of claim 1, wherein the receiving the command comprises:
determining whether a status is capable of receiving commands from the system memory based on the received information; and
being on standby until the status is capable of receiving the commands from the system memory if the status is not capable of receiving the commands from the system memory, and receiving the commands from the system memory based on the received information if the status is capable of receiving the commands from the system memory.

4. The method of claim 1, wherein the generating the interrupt further comprises:
determining whether a space exists for storing the received command in a register; and
storing the received command in the register if it is determined that the space exists for storing the received command in the register, and being on standby until there is the space for storing the received command in the register if it is determined that there is no space for storing the received command in the register.

5. The method of claim 1, wherein the generating the interrupt further comprises:
storing the received command in a register; and
repeating the receiving the command if commands represented by the information stored in the system memory remain in the system memory.

6. The method of claim 1, wherein in the receiving the command, if the number of received information pieces is equal to or greater than two, commands corresponding to the two or more received information pieces are substantially concurrently received from the system memory.

7. The method of claim 1, wherein the commands stored in the system memory are generated by at least one of a central processing unit and a flash translation layer.

8. A computer-readable recording medium having embodied thereon a computer program for executing a method of controlling commands for a flash memory, the method comprising, comprising:
receiving information on at least one command currently stored in a system memory;
receiving a command represented by the received information from the system memory; and
generating an interrupt representing that all commands for the flash memory are received, if receiving of all the commands represented by the received information has been completed.

9. The computer readable medium of claim 8, wherein information on the at least one command currently stored in the system memory comprises:
a number of commands stored in the system memory; and
an address in the system memory in which the commands are stored.

10. The computer readable medium of claim 8, wherein the receiving the command comprises:
determining whether a status is capable of receiving commands from the system memory based on the received information; and
being on standby until the status is capable of receiving the commands from the system memory if the status is not capable of receiving the commands from the system memory, and receiving the commands from the system memory based on the received information if the status is capable of receiving the commands from the system memory.

11. The computer readable medium of claim 8, wherein the generating the interrupt further comprises:
determining whether a space exists for storing the received command in a register; and
storing the received command in the register if it is determined that the space exists for storing the received command in the register, and being on standby until there is the space for storing the received command in the register if it is determined that there is no space for storing the received command in the register.

12. The computer readable medium of claim 8, wherein the generating the interrupt further comprises:
storing the received command in a register; and
repeating the receiving the command if commands represented by the information stored in the system memory remain in the system memory.

13. The computer readable medium of claim 8, wherein in the receiving the command, if the number of received information pieces is equal to or greater than two, commands corresponding to the two or more received information pieces are substantially concurrently received from the system memory.

14. A device for controlling commands for a flash memory, the device comprising:
a first register which stores information regarding at least one command currently stored in a system memory; and
a direct memory access (DMA) controller which receives commands represented by the information stored in the first register from the system memory and generates an interrupt representing that all commands for the flash memory are received if all the commands represented by the stored information are received.

15. The device of claim 14, wherein the information on the at least one command currently stored in the system memory includes a number of commands stored in the system memory, and an address in the system memory in which the commands are stored.

16. The device of claim 14,
wherein the DMA controller determines whether a status is capable of receiving the commands from the system memory based on the stored information,
wherein, if it is determined that the status is not capable of receiving the commands from the system memory, the DMA controller is on standby until the status is capable of receiving the commands from system memory, and
wherein, if it is determined that the status is capable of receiving the commands from the system memory, the DMA controller directly receives the commands from the system memory based on the received information.

17. The device of claim 14, wherein the DMA controller determines whether there is a space for storing the received command in a register, stores the received command in the register if it is determined there is the space for storing the received command in the register, and is on standby until there is the space for storing the received command in the register if it is determined that there is no space for storing the received command in the register.

18. The device of claim 14, further comprising a second register which stores commands received from the system memory.

19. The device of claim 14, wherein if a number of information pieces stored in the first register is substantially equal to or greater than two, the DMA controller concurrently receives commands corresponding to the two or more information pieces from the system memory.

20. The device of claim 14, wherein the commands stored in the system memory are generated by at least one of a central processing unit and a flash translation layer.
